(19) United States
(12) Patent Application Publication
(10) Pub. No.: US 2026/0121088 A1
(43) Pub. Date: Apr. 30, 2026

(54) SYSTEM AND METHOD FOR SPONTANEOUS WASTE HEAT RECOVERY FROM HYDROGEN FUEL CELL IN POLAR ENVIRONMENTS

(71) Applicant: Taiyuan University of Technology, Taiyuan City (CN)

(72) Inventors: Yonggang LEI, Taiyuan City (CN); Bowen ZHANG, Taiyuan City (CN); Hongbin SUN, Taiyuan City (CN); Qi TIAN, Taiyuan City (CN); Yixun XUE, Taiyuan City (CN); Chongfang SONG, Taiyuan City (CN)

(21) Appl. No.: 19/009,368

(22) Filed: Jan. 3, 2025

(30) Foreign Application Priority Data
Oct. 27, 2024 (CN) 202411504886.3

(51) Int. Cl. H01M 8/04007

(52) U.S. Cl. CPC H01M 8/04052; H01M 8/04074

(57) ABSTRACT

Provided is a system and method for spontaneous waste heat recovery from a hydrogen fuel cell in polar environments. The system for spontaneous waste heat recovery includes a cabin, and a filtering device, an emergency lighting device, an energy storage battery and a hydrogen fuel cell power generation module that are mounted in the cabin, and a device for spontaneous waste heat recovery mounted at the side wall of the cabin. The device for spontaneous waste heat recovery includes an isolation cover, an arc-shaped track pipe, a seal pipe and a base. The present disclosure can drive the rotational movement of the evaporation chamber and the condensation chamber by means of evaporation and condensation of the working medium without electric power to make the evaporation chamber and the condensation chamber to be successively in contact with the first piezoelectric ceramic and the second piezoelectric ceramic.

### CROSS-REFERENCE TO RELATED APPLICATION

This patent application claims the benefit and priority of Chinese Patent Application No. 202411504886.3 filed with the China National Intellectual Property Administration on Oct. 27, 2024, the disclosure of which is incorporated by reference herein in its entirety as part of the present application.

### TECHNICAL FIELD

The present disclosure relates to the technical field of energy recycling in the polar environments, and in particular to a system and method for spontaneous waste heat recovery from a hydrogen fuel cell in polar environments.

### BACKGROUND

The Polar regions, Antarctic and Arctic, are the coldest areas on the earth due to their high altitudes, rarefied air and extensive cryoconite cover, these unique polar environments create ideal places for scientific expeditions, astronomical observations and environmental experiments. Therefore, many countries have been attracted to establish research stations in the Antarctic and Arctic. However, these extreme environments pose more serious challenges to clean energy supply.

At present, most of the research stations generate power by means of diesel generator sets, causing more fuel and more pollution problems in these polar environments. Hydrogen fuel cells are expected to replace the diesel generator sets thanks to their characteristics such as high power generation efficiency, no pollution, and low noise. However, the hydrogen fuel cell is a power generation device using electrochemical reaction, which generates a large amount of high-temperature waste heat during power generation. In order to effectively utilize this high-temperature waste heat, a solution is using a waste heat recovery technology to improve the power generation efficiency and reliability on the basis of the low temperature characteristic of the polar environments. By capturing the waste heat generated by the hydrogen fuel cells and converting the waste heat into a reusable energy source, energy waste can be reduced, and the service life of the device is prolonged. This technology not only improves performance of the power generation system, but also reduces operating costs. Therefore, in the Antarctic research stations, a clean energy-based power generation systems using the waste heat recovery technology is conducive to meeting the challenges of extreme environments.

### SUMMARY

The main objective of the present disclosure is to overcome the shortcomings in the prior art, solve the technical problem of recovery and reuse of high-temperature waste heat generated by electrochemical reaction of hydrogen fuel cells in polar environments, and provide a system and method for spontaneous waste heat recovery from hydrogen fuel cell in polar environments. According to the low temperature characteristic of the polar environment, the present disclosure improves the speed of alternating evaporation and condensation of a heat exchange working medium by using a large temperature difference, so that the rotational movements of an evaporation chamber and a condensation chamber are rapidly driven, thus the evaporation chamber and the condensation chamber are made successively in contact with a first piezoelectric ceramic and a second piezoelectric ceramic, and a strong magnetic piston is pushed to slide, therefore achieving the functions of recovering waste heat of equipment, providing differential-pressure emergency lighting, charging an energy storage battery and compressing air to provide oxygen for a hydrogen fuel cell in polar environments.

The present disclosure is implemented by the following technical solution. A system for spontaneous waste heat recovery from a hydrogen fuel cell in polar environments is provided. The system includes a cabin, and a filtering device, an emergency lighting device, an energy storage battery and a hydrogen fuel cell power generation module that are mounted inside the cabin, and a device for spontaneous waste heat recovery mounted at a side wall of the cabin.

The device for spontaneous waste heat recovery includes an isolation cover, an arc-shaped track pipe, a seal pipe and a base; the isolation cover is mounted on an outer side wall of the cabin, a through hole is formed at a position, corresponding to the isolation cover, on the outer side wall of the cabin, and the isolation cover is in communication with the cabin;

The base is provided inside the cabin, a first support and a second support opposite to each other are provided on the base, and the first support is close to one side of the isolation cover; a middle of the seal pipe is articulated to a top of the first support, the seal pipe reciprocally swings around an articulation position where the seal pipe is articulated to the first support, a middle of the arc-shaped track pipe is fixedly mounted on a top of the second support, the arc-shaped track pipe is internally provided with a strong magnetic piston capable of reciprocally sliding along the arc-shaped track pipe; a suction device and an exhaust device are provided at a pipe orifice of a lower portion of the arc-shaped track pipe, and the suction device and the exhaust device are turned on and turned off alternately; the suction device is in communication with one end of a suction pipe, an other end of the suction pipe extends through the cabin and is exposed to the a polar environment outside the cabin, the exhaust device is in communication with one end of an exhaust pipe, and an other end of the exhaust pipe is in communication with a compressed air inlet of the hydrogen fuel cell power generation module; the suction device is configured to suck air in the polar environment into the arc-shaped track pipe, a closed cavity is formed by the strong magnetic piston and a bottom of an inner cavity of the arc-shaped track pipe, the air sucked into the closed cavity is configured to be compressed by the strong magnetic piston, and the compressed air is configured to be delivered to the compressed air inlet of the hydrogen fuel cell power generation module by the exhaust device through the exhaust pipe.

The seal pipe is filled with a room-temperature spontaneously evaporating liquid working medium, the seal pipe runs through the through hole formed in the outer side wall of the cabin, a condensation chamber is provided at an end of the seal pipe located inside the isolation cover, and an evaporation chamber is provided at an other end of the seal pipe located inside the cabin; the condensation chamber, the seal pipe and the evaporation chamber are in communication with one another, a strong magnetic magnet is fixedly provided on an outer wall of the evaporation chamber, and the strong magnetic magnet magnetically attracts the strong magnetic piston in a non-contact manner; the evaporation chamber is configured to absorb high-temperature waste heat generated by the hydrogen fuel cell power generation module, the room-temperature spontaneously evaporating liquid working medium in the evaporation chamber is configured to be heated to evaporate into the condensation chamber along the seal pipe, and a gaseous working medium inside the condensation chamber is configured to be cooled to condense into droplets to fall back into the evaporation chamber.

A first piezoelectric ceramic is provided at an upward stroke stop position of the condensation chamber in an inner cavity of the isolation cover, a second piezoelectric ceramic is provided at an upward stroke stop position of the evaporation chamber in an inner cavity of the cabin, the first piezoelectric ceramic and the second piezoelectric ceramic are electrically connected to the filtering device via first wires, and the filtering device is electrically connected to the emergency lighting device and the energy storage battery via second wires.

Furthermore, the isolation cover is fixedly embedded on the outer side wall of the cabin.

Furthermore, a heat insulating flexible telescopic tube is provided between a lower edge of the through hole in the outer side wall of the cabin and the seal pipe.

Furthermore, the evaporation chamber is externally wrapped with a heat absorption layer, and the condensation chamber is externally wrapped with a heat dissipation layer.

Furthermore, the isolation cover, the heat dissipation layer and the heat absorption layer are all made of a transparent material.

Furthermore, bristles are arranged on a lower inner wall of the inner cavity of the condensation chamber, the bristles have hard roots and soft tips, and the closer one of the bristles is located from the seal pipe, the smaller a length of said one of the bristles is.

Furthermore, the suction device is a one-way inlet valve, and the exhaust device is a one-way exhaust valve.

A method for spontaneous waste heat recovery from a hydrogen fuel cell in polar environments by means of the above-described system includes:
S1, in an initial state in which the condensation chamber is in the upward stroke stop position thereof, the condensation chamber is in contact with the first piezoelectric ceramic, as the room-temperature spontaneously evaporating liquid working medium in the evaporation chamber captures the waste heat generated by the hydrogen fuel cell power generation module, heating the room-temperature spontaneously evaporating liquid working medium to evaporate to be gaseous and to the condensation chamber along the seal pipe, thus gradually decreasing a weight of the room-temperature spontaneously evaporating liquid working medium in the evaporation chamber; cooling the room-temperature spontaneously evaporating liquid working medium in a gaseous state in the condensation chamber to be condensed into the droplets, thus gradually increasing a weight of the room-temperature spontaneously evaporating liquid working medium in the condensation chamber to drive the seal pipe to rotate around the articulation position in a counterclockwise direction; and meanwhile, turning off the exhaust device, turning on the suction device, driving the strong magnetic piston in the arc-shaped track pipe by the strong magnetic magnet to simultaneously slide in the counterclockwise direction during rotation of the seal pipe, sucking air outside the cabin into the closed cavity of the arc-shaped track pipe by the suction device through the suction pipe, thus beginning a process of sucking air into the closed cavity, and preheating the air sucked into the closed cavity by the waste heat generated by the hydrogen fuel cell power generation module;
S2, when the evaporation chamber is rotated to the upward stroke stop position thereof, contacting the evaporation chamber with the second piezoelectric ceramic, and transmitting a direct current generated by the second piezoelectric ceramic to the filtering device via one of the first wires for being filtered, transmitting the filtered direct current to the energy storage battery for charging, and simultaneously transmitting the filtered direct current to the emergency lighting device for illumination; and while the condensation chamber is in a downward stroke stop position thereof, reducing a wall surface temperature of the condensation chamber by a low-temperature polar environment outside the cabin through the isolation cover and the heat dissipation layer by cold radiation to condense the room-temperature spontaneously evaporating liquid working medium in the gaseous state in the condensation chamber; bouncing part of the droplets of the room-temperature spontaneously evaporating liquid working medium by the bristles back into the evaporation chamber to accelerate backflow of the room-temperature spontaneously evaporating liquid working medium, thus driving the seal pipe to rotate around the articulation position in a clockwise direction, turning off the suction device and the exhaust device, thus beginning a process of compressing air in the closed cavity;
S3, when the evaporation chamber is rotated again to a downward stroke stop position thereof, turning on the exhaust device and turning off the suction device, thus beginning a process of exhausting air in the closed cavity, and delivering preheated high-pressure air to the compressed air inlet of the hydrogen fuel cell power generation module by the exhaust device through the exhaust pipe for power generation of the hydrogen fuel cell power generation module; while the condensation chamber is in the upward stroke stop position thereof and is in contact with the first piezoelectric ceramic again, transmitting a direct current generated by the first piezoelectric ceramic to the filtering device via an other of the first wires for being filtered, transmitting the filtered direct current to the energy storage battery for charging, and simultaneously transmitting the filtered direct current to the emergency lighting device for illumination; and
S4, repeating S1-S3 described above to complete the spontaneous waste heat recovery from the hydrogen fuel cell in polar environments.

The present disclosure has the following beneficial effects.

On the basis of the low temperature characteristic of the polar environment, the present disclosure is especially suitable for spontaneous waste heat recovery from the hydrogen fuel cell in the polar environments by the evaporation and condensation of the working medium, therefore achieves the functions of providing differential-pressure emergency lighting, charging the energy storage battery and compressing air to provide oxygen for the hydrogen fuel cell. The device has the advantages, such as novel structure, simple control and fast response.

### BRIEF DESCRIPTION OF THE DRAWINGS

FIG. 1 is a schematic structural front view of the present disclosure with a hydrogen fuel cell power generation module omitted;

FIG. 2 is a schematic diagram of a suction process in a closed cavity of an arc-shaped track pipe according to the present disclosure;

FIG. 3 is a schematic diagram of a compression process in the closed cavity of the arc-shaped track pipe according to the present disclosure;

FIG. 4 is a schematic diagram of an exhaust process in the closed cavity of the arc-shaped track pipe according to the present disclosure.

Reference numerals: 1 Cabin; 2. Isolation cover; 3 Heat insulating flexible telescopic tube; 4 First support; 5 Bristle; 6 Heat dissipation layer; 7 Condensation chamber; 8 First piezoelectric ceramic; 9 Filtering device; 10 Emergency lighting device; 11 Wire; 12 Second piezoelectric ceramic; 13 Arc-shaped track pipe; 14 Second support; 15 Exhaust device; 16 Suction device; 17 Strong magnetic magnet; 18 Evaporation chamber; 19 Heat absorption layer; 20 Seal pipe; 21 Strong magnetic piston; 22 Energy storage battery; 23 Base; 24 Exhaust pipe; 25 Hydrogen fuel cell power generation module; and 26 Suction pipe.

### DETAILED DESCRIPTION OF THE EMBODIMENTS

The present disclosure will be further described in detail below with reference to the accompanying drawings and embodiments.

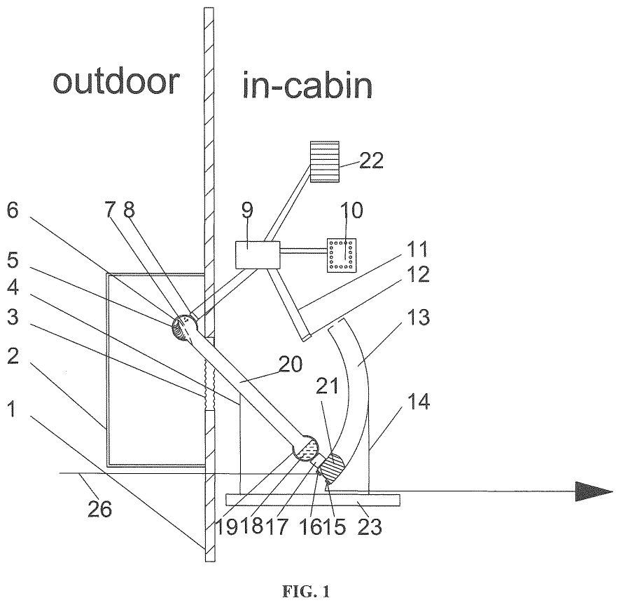

FIG. 1 shows a system for spontaneous waste heat recovery from a hydrogen fuel cell in polar environments including a cabin 1, and a filtering device 9, an emergency lighting device 10, an energy storage battery 22 and a hydrogen fuel cell power generation module 25 that are mounted inside the cabin 1, and a device for spontaneous waste heat recovery mounted at a side wall of the cabin 1.

The device for spontaneous waste heat recovery includes an isolation cover 2, an arc-shaped track pipe 13, a seal pipe 20 and a base 23. The isolation cover 2 is mounted on an outer side wall of the cabin 1, a through hole is formed at a position, corresponding to the isolation cover 2, on the outer side wall of the cabin 1, and the isolation cover 2 is in communication with the cabin 1.

The base 23 is provided inside the cabin 1, a first support 4 and a second support 14 opposite to each other are provided on the base 23, and the first support 4 is close to one side of the isolation cover 2. The middle of the seal pipe 20 is articulated to the top of the first support 4, the seal pipe 20 reciprocally swings around an articulation position where the seal pipe 20 is articulated to the first support 4. The middle of the arc-shaped track pipe 13 is fixedly mounted on the top of the second support 14, the arc-shaped track pipe 13 is internally provided with a strong magnetic piston 21 capable of reciprocally sliding along the arc-shaped track pipe 13. A suction device 16 and an exhaust device 15 are provided at a pipe orifice of the lower portion of the arc-shaped track pipe 13, and the suction device 16 and the exhaust device 15 are turned on and turned off alternately. The suction device 16 is in communication with one end of a suction pipe 26, the other end of the suction pipe 26 extends through the cabin 1 and is exposed to the external polar environment. The exhaust device 15 is in communication with one end of an exhaust pipe 24, and the other end of the exhaust pipe 24 is in communication with a compressed air inlet of the hydrogen fuel cell power generation module 25. The suction device 16 is configured to suck air in the polar environment into the arc-shaped track pipe 13, a closed cavity is formed by the strong magnetic piston 21 and the bottom of an inner cavity of the arc-shaped track pipe 13, the air sucked into the closed cavity is configured to be compressed by the strong magnetic piston 21, and the compressed air is configured to be delivered to the compressed air inlet of the hydrogen fuel cell power generation module 25 by the exhaust device 15 through the exhaust pipe 24.

The seal pipe 20 is filled with a room-temperature spontaneously evaporating liquid working medium, the seal pipe 20 runs through the through hole formed in the outer side wall of the cabin 1, a condensation chamber 7 is provided at an end of the seal pipe 20 located inside the isolation cover 2, and an evaporation chamber 18 is provided at an end of the seal pipe 20 located inside the cabin 1. The condensation chamber 7, the seal pipe 20 and the evaporation chamber 18 are in communication with one another. A strong magnetic magnet 17 is fixedly provided on an outer wall of the evaporation chamber 18, and the strong magnetic magnet 17 magnetically attracts the strong magnetic piston 21 in a non-contact manner. The evaporation chamber 18 is configured to absorb high-temperature waste heat generated by the hydrogen fuel cell power generation module 25, the room-temperature spontaneously evaporating liquid working medium in the evaporation chamber 18 is configured to be heated to evaporate into the condensation chamber 7 along the seal pipe 20, and a gaseous working medium inside the condensation chamber 7 is cooled and then condensed into droplets to fall back into the evaporation chamber 18. On this basis, since the isolation cover 2 is located in the polar low-temperature environment, the temperature inside the isolation cover 2 is obviously lower than the temperature inside the cabin 1, such that the liquefaction of the gaseous working medium inside the condensation chamber 7 is promoted.

A first piezoelectric ceramic 8 is provided at an upward stroke stop position of the condensation chamber 7 in an inner cavity of the isolation cover 2, a second piezoelectric ceramic 12 is provided at an upward stroke stop position of the evaporation chamber 18 in the inner cavity of the cabin 1. The first piezoelectric ceramic 8 and the second piezoelectric ceramic 12 are electrically connected to the filtering device 9 via wires 11. The filtering device rectifies and filters unstable currents generated by the first piezoelectric ceramic and the second piezoelectric ceramic, the filtering device 9 is electrically connected to the emergency lighting device 10 and the energy storage battery 22 via wires. The emergency lighting device includes low-power-consumption LED lamps to provide emergency lighting to a hydrogen fuel cell cabin.

Furthermore, the isolation cover 2 is fixedly embedded on the outer side wall of the cabin 1.

Furthermore, a heat insulating flexible telescopic tube 3 is provided between the lower edge of the through hole in the outer side wall of the cabin 1 and the seal pipe 20.

Furthermore, the evaporation chamber 18 is externally wrapped with a heat absorption layer 19 to further improve the efficiency of heat absorption and evaporation of the room-temperature spontaneously evaporating liquid working medium; and the condensation chamber 7 is externally wrapped with a heat dissipation layer 6 to further improve the efficiency of heat dissipation and condensation of the gaseous working medium.

Furthermore, the isolation cover 2, the heat dissipation layer 6 and the heat absorption layer 19 are all made of a transparent material.

Furthermore, bristles 5 are arranged on a lower inner wall of the inner cavity of the condensation chamber 7, the bristles 5 have hard roots and soft tips, and the closer one of the bristles 5 is located from the seal pipe 20, the smaller the length of said one of the bristles 5 is, which are conducive to bouncing the droplets of liquid working medium back into an evaporation section accelerating the backflow of the liquid working medium.

Furthermore, the suction device 16 is a one-way inlet valve, and the exhaust device 15 is a one-way exhaust valve.

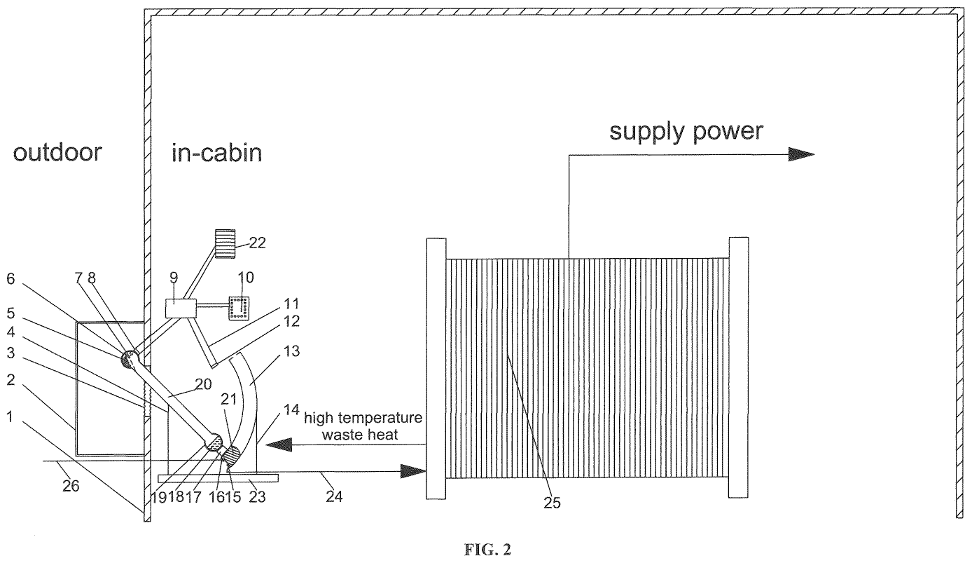

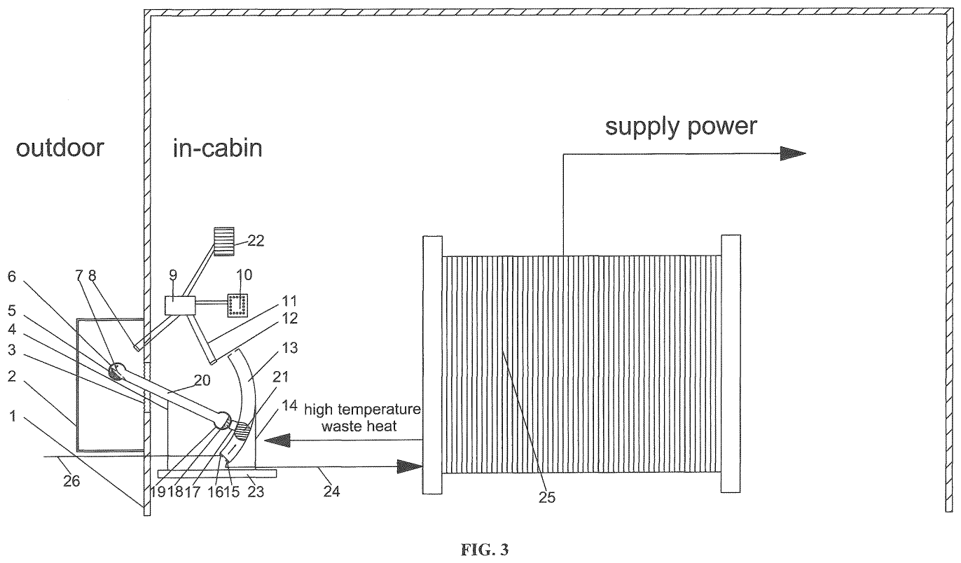

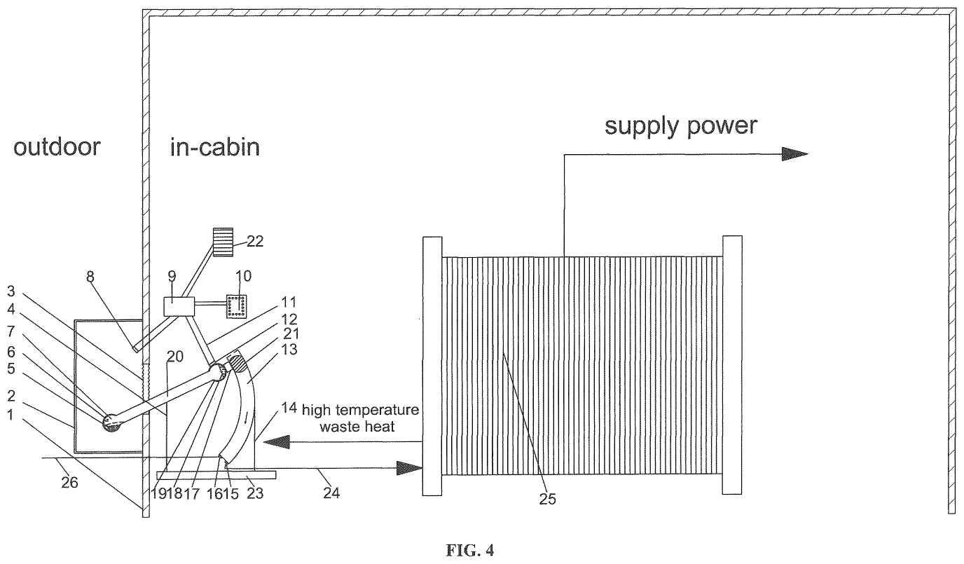

As shown in FIGS. 2 to 4, a method for spontaneous waste heat recovery from a hydrogen fuel cell in polar environments by means of the above-described system includes the following steps:
S1, in an initial state, in which the condensation chamber 7 is in the upward stroke stop position, the condensation chamber 7 is in contact with the first piezoelectric ceramic 8, as the room-temperature spontaneously evaporating liquid working medium in the evaporation chamber 18 captures the waste heat generated by the hydrogen fuel cell power generation module 25, so that the room-temperature spontaneously evaporating liquid working medium is heated to be evaporated to be gaseous and to the condensation chamber 7 along the seal pipe 20, thus gradually decreasing the weight of the room-temperature spontaneously evaporating liquid working medium in the evaporation chamber 18; the gaseous working medium in the condensation chamber 7 is cooled to be condensed into the droplets, thus gradually increasing the weight of the room-temperature spontaneously evaporating liquid working medium in the condensation chamber 7 and then driving the seal pipe 20 to rotate around the articulation position in a counterclockwise direction; and meanwhile, the exhaust device 15 is turned off, the suction device 16 is turned on, the strong magnetic magnet 17 drives the strong magnetic piston 21 in the arc-shaped track pipe 13 to simultaneously slide in the counterclockwise direction during the rotation of the seal pipe 20, the air outside the cabin 1 is sucked into the closed cavity of the arc-shaped track pipe 13 by the suction device 16 through the suction pipe 26, a process of sucking air into the closed cavity begins, and the waste heat generated by the hydrogen fuel cell power generation module 25 preheats the air sucked into the closed cavity;
S2, when the evaporation chamber 18 is rotated to the upward stroke stop position, the evaporation chamber 18 is in contact with the second piezoelectric ceramic 12, and a direct current generated by the second piezoelectric ceramic 12 is transmitted to the filtering device 9 via the wire 11 for being filtered, the filtered direct current is transmitted to the energy storage battery 22 for charging, and is simultaneously transmitted to the emergency lighting device 10 for illumination; and while the condensation chamber 7 is in a downward stroke stop position, and the low-temperature polar environment outside the cabin reduces a wall surface temperature of the condensation chamber 7 through the isolation cover 2 and the heat dissipation layer 6 by cold radiation to condense the gaseous working medium in the condensation chamber, while the bristles 5 bounce part of the droplets of the liquid working medium back into the evaporation chamber 18 to accelerate the backflow of the liquid working medium, thus driving the seal pipe 20 to rotate about the articulation position in a clockwise direction, the suction device 16 and the exhaust device 15 are both turned off at this time, and a process of compressing air in the closed cavity begins;
S3, when the evaporation chamber 18 be rotated again to the downward stroke stop position thereof, the exhaust device 15 is turned on and the suction device 16 is turned off at this time, a process of exhausting air in the closed cavity begins, and preheated high-pressure air is delivered to a compressed air inlet of the hydrogen fuel cell power generation module 25 by the exhaust device 15 through the exhaust pipe 24 for the power generation of the hydrogen fuel cell power generation module 25; at this time, the condensation chamber 7 is in the upward stroke stop position and is in contact with the first piezoelectric ceramic 8 again, a direct current generated by the first piezoelectric ceramic 8 is transmitted to the filtering device 9 for be filtered via the wire 11, the filtered direct current is transmitted to the energy storage battery 22 for charging, and is simultaneously transmitted to the emergency lighting device 10 for illumination; and
S4, steps S1-S3 described above are repeated to complete the spontaneous waste heat recovery from the hydrogen fuel cell in polar environments.

The foregoing descriptions are merely specific implementations of the present disclosure, but are not intended to limit the scope of protection of the present disclosure. Any variations or replacements readily figured out by a person skilled in the art within the technical scope disclosed in the present disclosure shall fall within the scope of protection of the present disclosure. Therefore, the scope of protection of the present disclosure shall be subject to the scope of protection of the claims.

What is claimed is:

1. A system for spontaneous waste heat recovery from a hydrogen fuel cell in polar environments, comprising:
a cabin,
a filtering device, an emergency lighting device, an energy storage battery and a hydrogen fuel cell power generation module that are mounted inside the cabin, and
a device for spontaneous waste heat recovery mounted at a side wall of the cabin comprising:
an isolation cover mounted on an outer side wall of the cabin, wherein a through hole is formed at a position, corresponding to the isolation cover, on the outer side wall of the cabin, and the isolation cover is in communication with the cabin;
an arc-shaped track pipe internally provided with a strong magnetic piston capable of reciprocally sliding along the arc-shaped track pipe;
a seal pipe filled with a room-temperature spontaneously evaporating liquid working medium, wherein the seal pipe runs through the through hole formed in the outer side wall of the cabin, a condensation chamber is provided at an end of the seal pipe located inside the isolation cover, and an evaporation chamber is provided at an other end of the seal pipe located inside the cabin and fixedly provided with a strong magnetic magnet on an outer wall thereof; the condensation chamber, the seal pipe and the evaporation chamber are in communication with one another, wherein the strong magnetic magnet magnetically attracts the strong magnetic piston in a non-contact manner; the evaporation chamber is configured to absorb high-temperature waste heat generated by the hydrogen fuel cell power generation module, the room-temperature spontaneously evaporating liquid working medium in the evaporation chamber is configured to be heated to evaporate into the condensation chamber along the seal pipe, and a gaseous working medium inside the condensation chamber is configured to be cooled to condense into droplets to fall back into the evaporation chamber; and
a base provided inside the cabin and provided with a first support and a second support opposite each other thereon, the first support being close to one side of the isolation cover;
wherein a middle of the seal pipe is articulated to a top of the first support, the seal pipe reciprocally swings around an articulation position where the seal pipe is articulated to the first support,
a middle of the arc-shaped track pipe is fixedly mounted on a top of the second support;
a suction device and an exhaust device are provided at a pipe orifice of a lower portion of the arc-shaped track pipe, wherein the suction device and the exhaust device are turned on and turned off alternately, the suction device is in communication with one end of a suction pipe, an other end of the suction pipe extends through the cabin and is exposed to the a polar environment outside the cabin;
the exhaust device is in communication with one end of an exhaust pipe, and an other end of the exhaust pipe is in communication with a compressed air inlet of the hydrogen fuel cell power generation module;
the suction device is configured to suck air in the polar environment into the arc-shaped track pipe, wherein a closed cavity is formed by the strong magnetic piston and a bottom of an inner cavity of the arc-shaped track pipe, the air sucked into the closed cavity is configured to be compressed by the strong magnetic piston, and the compressed air is configured to be delivered to the compressed air inlet of the hydrogen fuel cell power generation module by the exhaust device through the exhaust pipe; and
a first piezoelectric ceramic is provided at an upward stroke stop position of the condensation chamber in an inner cavity of the isolation cover, a second piezoelectric ceramic is provided at an upward stroke stop position of the evaporation chamber in an inner cavity of the cabin, the first piezoelectric ceramic and the second piezoelectric ceramic are electrically connected to the filtering device via first wires, and the filtering device is electrically connected to the emergency lighting device and the energy storage battery via second wires.

2. The system for spontaneous waste heat recovery from the hydrogen fuel cell in polar environments according to claim 1, wherein the isolation cover is fixedly embedded on the outer side wall of the cabin.

3. The system for spontaneous waste heat recovery from the hydrogen fuel cell in polar environments according to claim 1, further comprising a heat insulating flexible telescopic tube provided between a lower edge of the through hole in the outer side wall of the cabin and the seal pipe.

4. The system for spontaneous waste heat recovery from the hydrogen fuel cell in polar environments according to claim 1, wherein the evaporation chamber is externally wrapped with a heat absorption layer, and the condensation chamber is externally wrapped with a heat dissipation layer.

5. The system for spontaneous waste heat recovery from the hydrogen fuel cell in polar environments according to claim 1, wherein the isolation cover, the heat dissipation layer and the heat absorption layer are all made of a transparent material.

6. The system for spontaneous waste heat recovery from the hydrogen fuel cell in polar environments according to claim 1, further comprising bristles arranged on a lower inner wall of the inner cavity of the condensation chamber, the bristles have hard roots and soft tips, and the closer one of the bristles is located from the seal pipe, the smaller a length of said one of the bristles is.

7. The system for spontaneous waste heat recovery from the hydrogen fuel cell in polar environments according to claim 1, wherein the suction device is a one-way inlet valve, and the exhaust device is a one-way exhaust valve.

8. A method for spontaneous waste heat recovery from a hydrogen fuel cell in polar environments by means of the system according to claim 6, comprising:
S1, in an initial state in which the condensation chamber is in the upward stroke stop position thereof, the condensation chamber is in contact with the first piezoelectric ceramic, as the room-temperature spontaneously evaporating liquid working medium in the evaporation chamber captures the waste heat generated by the hydrogen fuel cell power generation module, heating the room-temperature spontaneously evaporating liquid working medium to evaporate to be gaseous and to the condensation chamber along the seal pipe, thus gradually decreasing a weight of the room-temperature spontaneously evaporating liquid working medium in the evaporation chamber; cooling the room-temperature spontaneously evaporating liquid working medium in a gaseous state in the condensation chamber to be condensed into the droplets, thus gradually increasing a weight of the room-temperature spontaneously evaporating liquid working medium in the condensation chamber to drive the seal pipe to rotate around the articulation position in a counterclockwise direction; and meanwhile, turning off the exhaust device, turning on the suction device, driving the strong magnetic piston in the arc-shaped track pipe by the strong magnetic magnet to simultaneously slide in the counterclockwise direction during rotation of the seal pipe, sucking air outside the cabin into the closed cavity of the arc-shaped track pipe by the suction device through the suction pipe, thus beginning a process of sucking air into the closed cavity, and preheating the air sucked into the closed cavity by the waste heat generated by the hydrogen fuel cell power generation module;
S2, when the evaporation chamber is rotated to the upward stroke stop position thereof, contacting the evaporation chamber with the second piezoelectric ceramic, and transmitting a direct current generated by the second piezoelectric ceramic to the filtering device via one of the first wires for being filtered, transmitting the filtered direct current to the energy storage battery for charging, and simultaneously transmitting the filtered direct current to the emergency lighting device for illumination; and while the condensation chamber is in a downward stroke stop position thereof, reducing a wall surface temperature of the condensation chamber by a low-temperature polar environment outside the cabin through the isolation cover and the heat dissipation layer by cold radiation to condense the room-temperature spontaneously evaporating liquid working medium in the gaseous state in the condensation chamber; bouncing part of the droplets of the room-temperature spontaneously evaporating liquid working medium by the bristles back into the evaporation chamber to accelerate backflow of the room-temperature spontaneously evaporating liquid working medium, thus driving the seal pipe to rotate around the articulation position in a clockwise direction, turning off the suction device and the exhaust device, thus beginning a process of compressing air in the closed cavity;
S3, when the evaporation chamber is rotated again to a downward stroke stop position thereof, turning on the exhaust device and turning off the suction device, thus beginning a process of exhausting air in the closed cavity, and delivering preheated high-pressure air to the compressed air inlet of the hydrogen fuel cell power generation module by the exhaust device through the exhaust pipe for power generation of the hydrogen fuel cell power generation module; while the condensation chamber is in the upward stroke stop position thereof and is in contact with the first piezoelectric ceramic again, transmitting a direct current generated by the first piezoelectric ceramic to the filtering device via an other of the first wires for being filtered, transmitting the filtered direct current to the energy storage battery for charging, and simultaneously transmitting the filtered direct current to the emergency lighting device for illumination; and
S4, repeating S1-S3 to complete the spontaneous waste heat recovery from the hydrogen fuel cell in polar environments.
